(19) United States
(12) Patent Application Publication
(10) Pub. No.: US 2025/0154014 A1
(43) Pub. Date: May 15, 2025

(54) CONTINUOUS FLOW SYNTHESIS OF MESOPOROUS SILICA PARTICLES

(71) Applicant: COUNCIL OF SCIENTIFIC AND INDUSTRIAL RESEARCH, New Delhi (IN)

(72) Inventors: Amol Arvindrao KULKARNI, Pune (IN); Rajashri Baburao JUNDALE, Pune (IN); Atul Harishchandra BARI, Pune (IN)

(21) Appl. No.: 18/838,937

(22) PCT Filed: Feb. 15, 2023
(86) PCT No.: PCT/IN2023/050153

§ 371 Date: Aug. 15, 2024

(30) Foreign Application Priority Data
Feb. 15, 2022 (IN) 202211008075

(51) Int. Cl. C01B 33/18

(52) U.S. Cl. CPC C01B 33/18; C01P 2002/01; C01P 2004/61; C01P 2004/62; C01P 2006/12; C01P 2006/16

(57) ABSTRACT

The present invention discloses a continuous flow synthesis of mesoporous silica particles by using a reactor at shorter reaction times. The particle size of mesoporous silica particles are in the range of 400 nm-1.5 microns. and is monodispersed. surface area >700 m²/g and pore size in the range of 2-4 nm.

### FIELD OF THE INVENTION

The present invention relates to a process for synthesis of mesoporous silica particles.

More particularly, the present invention relates to a continuous flow synthesis of mesoporous silica particles.

### BACKGROUND AND PRIOR ART OF THE INVENTION

Mesoporous silica particles have pores on the surface in the range of 2-50 nm. These particles can be synthesized in different morphology and the porous structure can also be tuned at different shape hexagonal, cubic and cylindrical. Mesoporous silica nanoparticles (MSNs) arose as promising drug delivery platforms and biomedicine applications because of their outstanding biocompatibility, their degradability, and their great chemical and biological robustness whereas micron size mesoporous silica particles used in chromatographic separation process such as HPLC for separation of larger molecules such as proteins. Also surface functionalization with organic group and fluorescent or MRI contrast agent makes this material an ideal candidate in optoelectronic device and catalysis processes.

Mesoporous Silica particles is conventionally synthesizing in batch reactors formed by hydrolysis and condensation of the silica precursor on the surface of micelles formed by surfactant self-assembly in aqueous solution. Various types of base catalysts are used and in general the reaction is time consuming, takes hours or few days for completion. Also requires precise control of parameters through drop wise addition of reagents.

Article titled “Continuous synthesis of monodisperse silica microspheres over 1 μm size”, Journal of Flow Chemistry volume 11, pages 831-842 (2021) discloses a robust and scalable method for synthesizing continuously the silica microspheres via the Stöber method, however the method is applicable for synthesis of rigid silica and not mesoporous silica using gas-liquid dispersion or slug flow.

Another Article titled “Synthesis of mesoporous silica SBA-15 using a dropwise flow reactor”, Korean Journal of Chemical Engineering Volume 36, pages 1410-1416 (2019), discloses a continuous drop flow synthesis of mesoporous silica at two different reaction stages at different temperatures. One further article titled “Continuous-flow synthesis of mesoporous SBA-15”, Microporous and Mesoporous Materials, Vol. 329, pp. 1-6; 2022,discloses a continuous process for preparation of SBA-15 mesoporous silica in a tubular reactor comprising PTFE tubing at 80° C., wherein, the silica has a BET surface of 566 m²g⁻¹ and ordered 5.1 nm mesopore channels. However, these article's reactions are carried out at higher temperature and the final product's structure is like threads or flakes with certain shape of pores i.e., not uniform or not preferred at all.

The present invention discloses a method for producing mesoporous silica in large scale through continuous flow synthesis process. Mono dispersed particles of diameter 400 to 1200 nm, surface area >700 m²/gm, and pore diameter 2-4 nm was produced using PTFE based tubular reactor in reaction time of few minutes. Process parameters are fine tuned in such a way that it doesn't allow clogging and wall deposition problems. This allows us to carry out continuous run for more than 6 hours without compromising quality of product. Hydrophobicity of surface, pH of solution, high temperature and composition of reactant makes this process ideal to give large through put of material.

### OBJECTIVE OF THE INVENTION

The main objective of the present invention is to provide a continuous flow synthesis of mesoporous silica particles by using PTFE tubular reactor at shorter reaction times.

### SUMMARY OF THE INVENTION

In an aspect, the present invention provides a continuous process for the synthesis of mesoporous silica comprising reacting an orthosilicate (0.01-0.4 M), a surfactant (0.003-0.08 M), methanol/water (50/50 v/v), TMB (0.001-0.06 M) and a reducing agent (0.0005-0.08 M) in a reactor with contact angle between reactor surface and reaction mass in the range of 30 to 170 degrees at a temperature range of 20 to 75° C., wherein the range of mole ratios of precursor: surfactant: basicity of reducing agent: TMB is 1:1.5:10:1.2 to 1:25:80:10 to obtain mesoporous silica particles characterized in that the particle size in the range of 400 nm-1.5 microns, and is mono dispersed, surface area >700 m²/g and pore size in the range of 2-4 nm.

In another aspect, the present invention relates to a continuous process for synthesis of a mesoporous silica particles comprising steps of:
a) preparing a reaction mixture 1 comprises of a surfactant, a reducing agent, water and methanol, and a reaction mixture 2 comprises of an ortho silicate, a TMB and a methanol, at inlet of a reactor;
b) passing and mixing the reaction mixtures 1 and 2 of step a) inside said reactor for a residence time of 10-30 minutes at a temperature ranging from 20-75° C.;
c) continuously running the step b) for a time period of 2 to 4 hours to obtain the mesoporous silica particles;
Wherein a contact angle between reactor surface and mixtures of the reaction mixture 1 and 2 is in the range of 30° to 170°.

In another embodiment, the particles obtained in step (c) are in the form of polydispersed, hollow and broken with a surface area of 700 m²/g to 1300 m²/g and a pore size of 2-4 nm.

In another embodiment, the present invention relates to a continuous process, wherein the particles obtained in step (c) are in the form of polydispersed, hollow and broken with the surface area of 1075 m²/g and pore size of 3.2 nm.

In yet another embodiment, the present invention relates to a continuous process, wherein ratio of orthosilicate: surfactant: reducing agent: TMB is in the range of 1:1.5:10:1.2 to 1:25:80:10.

In another embodiment, the present invention relates to a continuous process, wherein preparing reaction mixture 1 and 2 of step a) is done using a micromixer for mixing of reactants.

In another embodiment, the present invention relates to a continuous process, wherein the orthosilicate is tetraethyl orthosilicate or tetramethyl orthosilicate; and wherein the reducing agent is selected from ammonia solution, sodium hydroxide or dodecylamine, alone or in combination thereof.

In another embodiment, the present invention relates to a continuous process, wherein the surfactant is selected from Cetyltrimethylammonium bromide, Pluronic 123 (Poly (ethylene glycol)-block-poly (propylene glycol)-block-poly (ethylene glycol)), and Dodecylamine.

In yet another embodiment, the present invention relates to a continuous process, wherein the reactor is tubular reactor made of hydrophobic material, particularly the reactor is PTFE tubular reactor.

In another embodiment, the present invention relates to a continuous process, wherein the process is recyclable results in zero discharge of unreacted material.

In another embodiment, the present invention relates to a continuous process, wherein yield of the mesoporous silica is 30 to 70% per cycle.

In yet another embodiment, the present invention relates to a continuous process, wherein a particle size of the monodispersed mesoporous silica particles is in the range of 400 nm-1.5 microns; and wherein a surface area is in the range of 700 m²/g to 1300 m²/g; and wherein a pore size is in the range of 2-4 nm.

### Abbreviation

PTFE: Polytetrafluoroethylene
CTAB: Cetyltrimethylammonium bromide
TEOS: Tetraethyl orthosilicate
CSTR: Continuous stirred-tank reactor
NaOH: Sodium Hydroxide
TMB: 1,2,4-Trimethylbenzene

### BRIEF DESCRIPTION OF THE DRAWINGS

FIG. 1: SEM images of mesoporous silica particles prepared by batch process shown at a) 60000× magnification and b) 16000× magnification refer example 1.

FIG. 2: FE SEM images of mesoporous silica particles obtained by semi-batch process shown at a) 50000× magnification and b) 2000× magnification refer example 2. Values appears in the FIG. 2 (b) are the marking of particle diameter in μm.

FIG. 3: SEM images of mesoporous silica particles obtained in example 3 shown at a) 10000× magnification and b) 20000× magnification. Values appears in the FIG. 3(b) are the marking of particle diameter in nm.

FIG. 4: SEM images of mesoporous silica particles prepared by continuous flow synthesis process shown at a) 10000×, b) 20000×, Line and values appears in the FIG. 4(b) indicates the marking of particle diameter in um and c) HR-TEM image (scale bar 200 nm).

FIG. 5: SEM images of mesoporous silica particles obtained in example 5 by two phase flow a) 10000× magnification and b) 30000× magnification.

FIG. 6: SEM images obtained in example 6 a) 20000× and b) 50000× magnification.

FIG. 7: SEM images obtained in example 7 a) 30000×, and b) 10000× magnification. Green color line and values appears in the FIG. 7(a) indicates the marking of particle diameter in nm.

FIG. 8: SEM image obtained in example 8 shown at a) 20000× and b) 10000× magnification. Line and values appear in the FIG. 8(a) indicates the marking of particle diameter in nm.

FIG. 9: SEM image obtained in example 9 shown at 20000× magnification. Line and values appear in the FIG. 9 indicates the marking of particle diameter in nm.

FIG. 10: SEM image obtained in example 10 a) 20000× and b) 20000× magnification, Line and values appears in the FIG. 10 b) indicates the marking of particle diameter in μm.

FIG. 11: SEM image obtained in example 11 a) 20000×, Line and values appears in the figure indicates the marking of particle diameter in nm and b) 10000× magnification.

FIG. 12: FE-SEM image obtained in example 12 a) 240000× magnification and b) HR-TEM image (scale bar 100 nm).

FIG. 13: FE-SEM image obtained in example 13 a) 100000× and b) 200000× magnification.

FIG. 14: FE-SEM image obtained in example 14 a) 100000× and b) 80000× magnification.

FIG. 15: FE-SEM image obtained in example 15 a) 240000×, b) 60000× magnification Microscope images of surface, c) Teflon tube and d) PTFE tube.

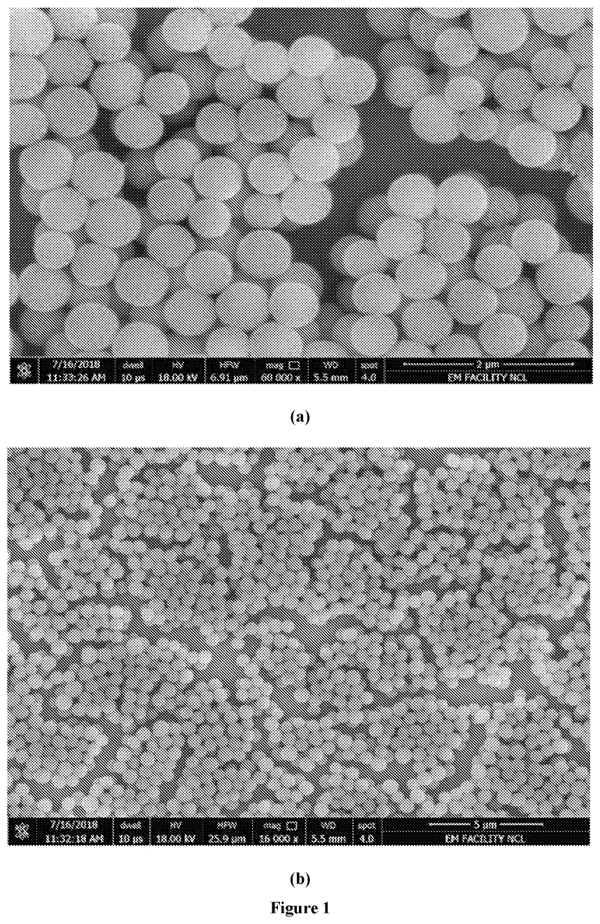

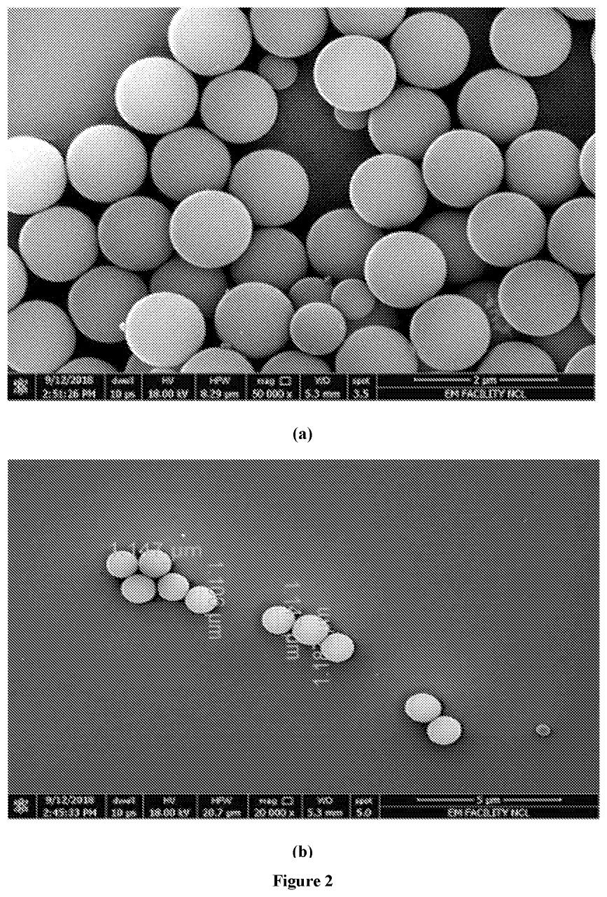

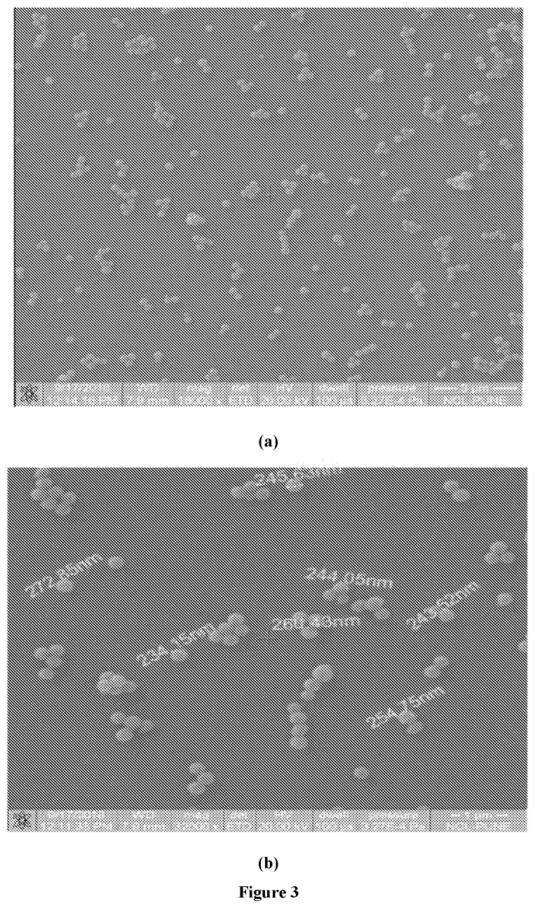

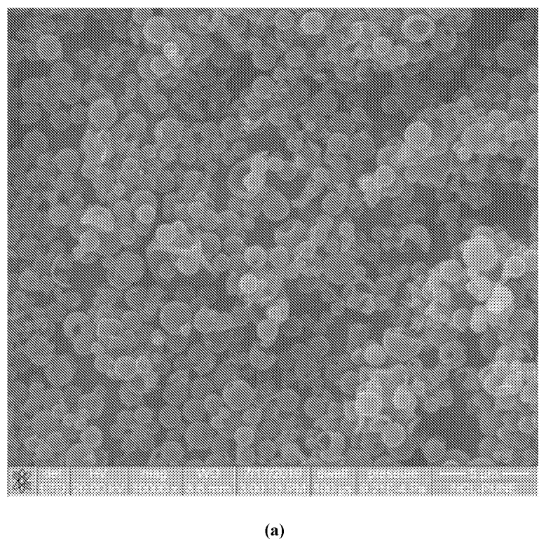

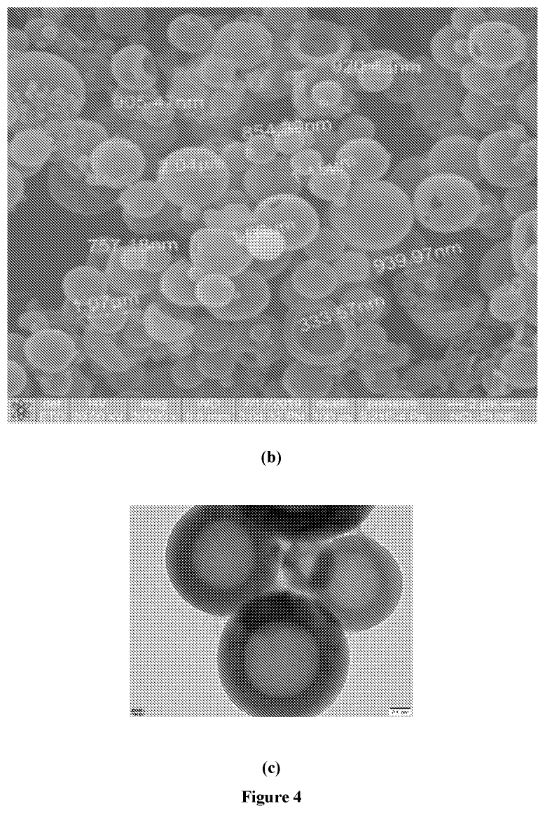

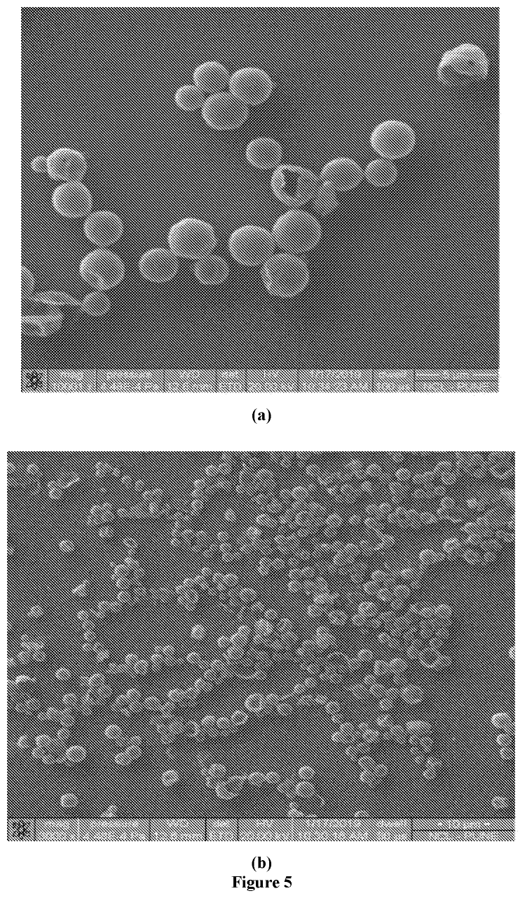

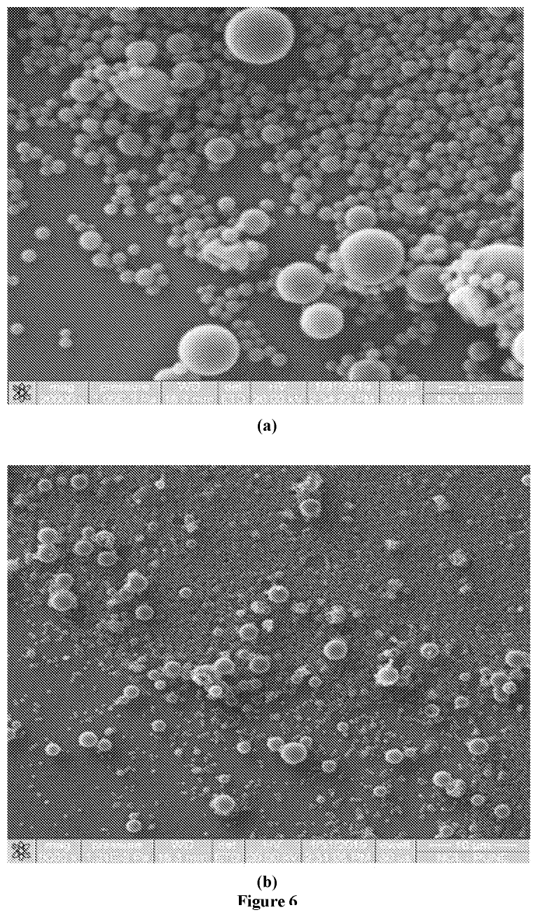

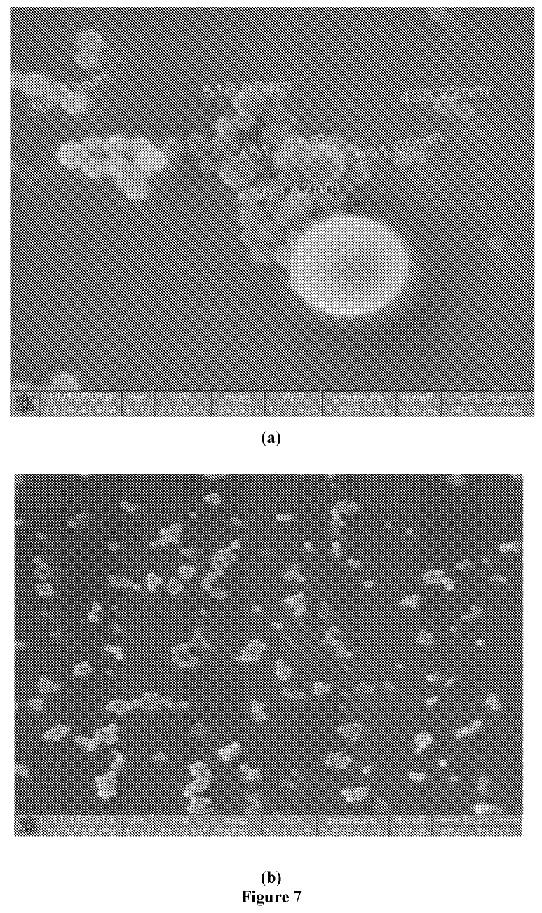

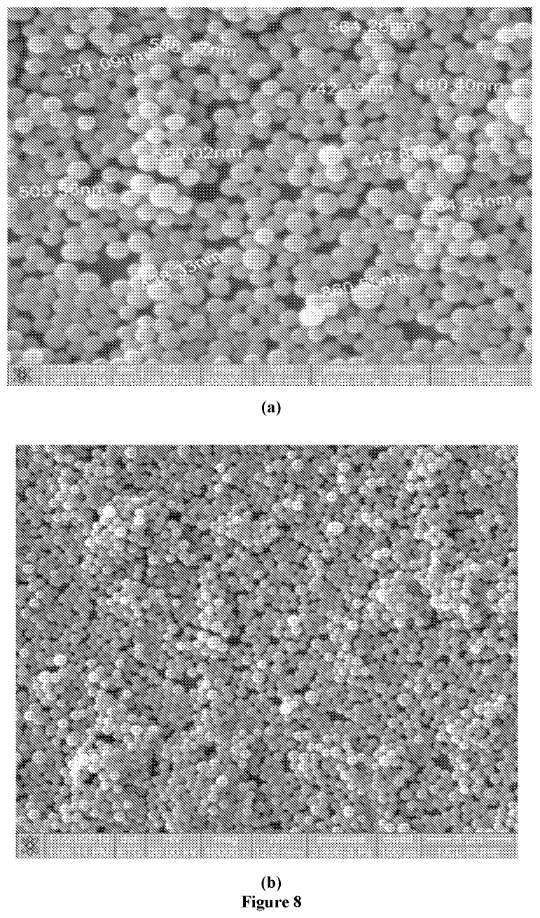

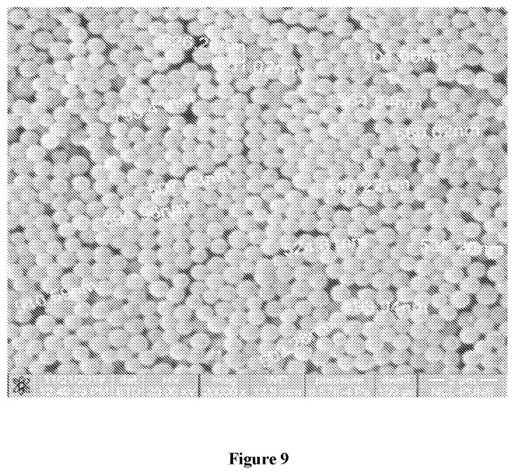

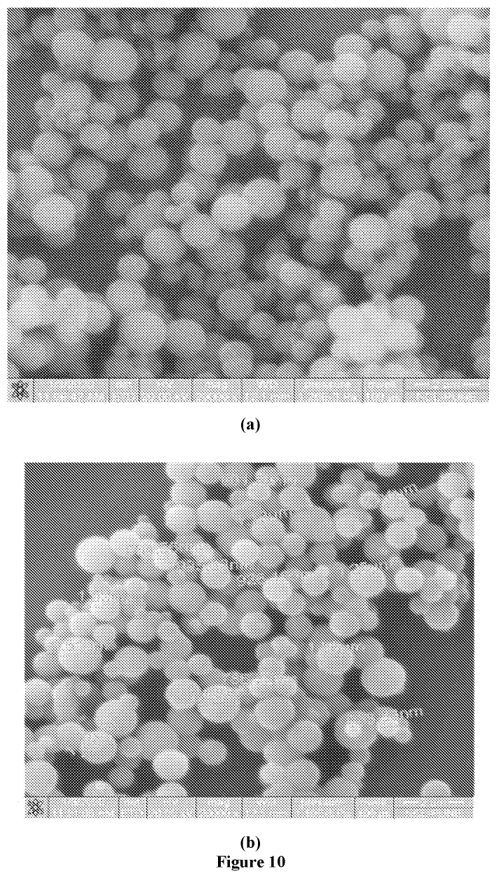

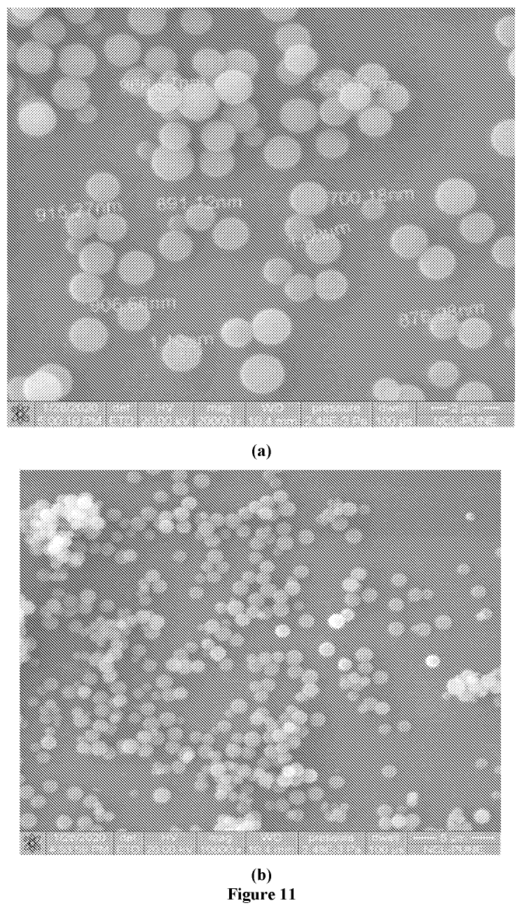

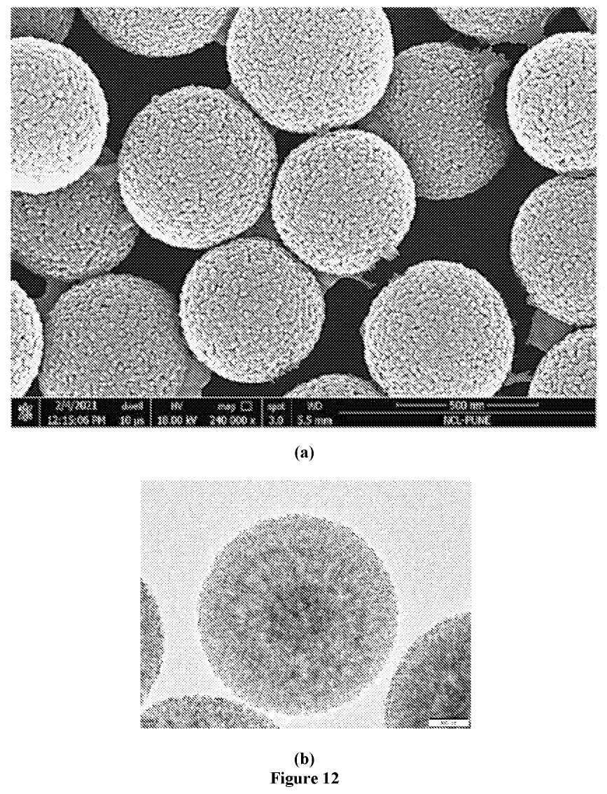

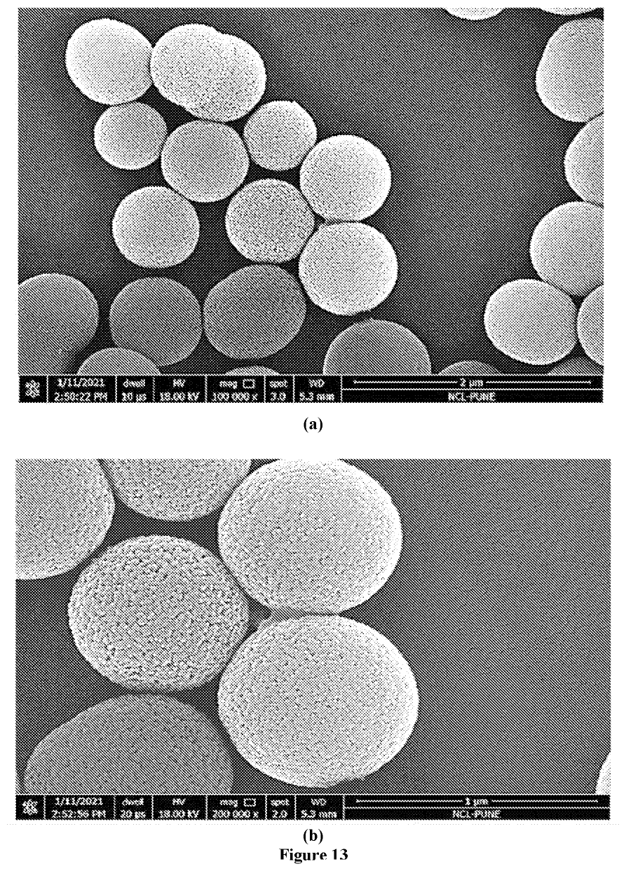

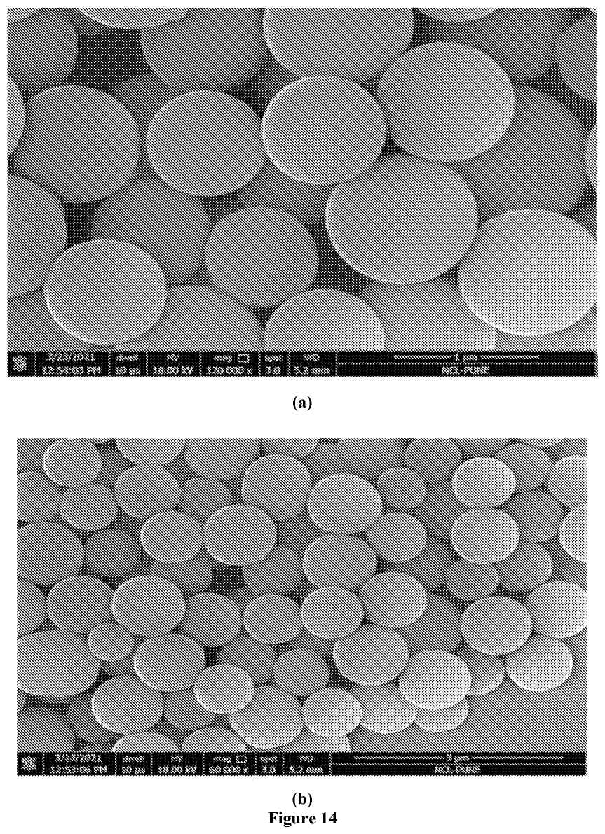

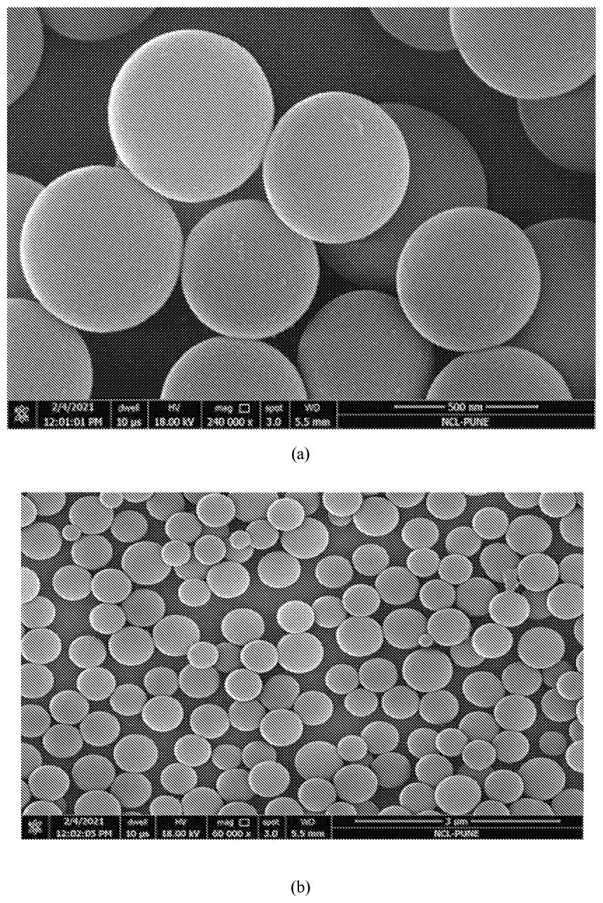

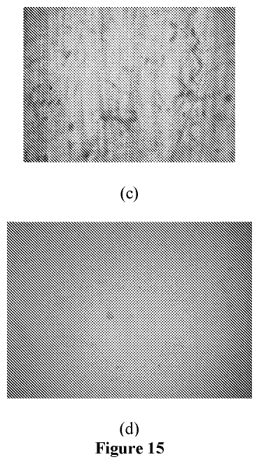

### DETAILED DESCRIPTION OF THE INVENTION

The invention will now be described in detail in connection with certain preferred and optional embodiments, so that various aspects thereof may be more fully understood and appreciated.

In an aspect, the present invention provides a continuous process for the synthesis of mesoporous silica comprising preparing and reacting a mixture comprising an ortho silicate, a surfactant, water, methanol, TMB and a reducing agent in a reactor with contact angle between reactor surface and reaction mass in the range of 30 to 170 degrees at a temperature range of 20 to 75° C., wherein the range of mole ratios of precursor:

surfactant: basicity of reducing agent: TMB is 1:1.5:10:1.2 to 1:25:80:10 10 to obtain mesoporous silica particles characterized in that the particle size in the range of 400 nm-1.5 microns, and is monodispersed, surface area >700 m²/g and pore size in the range of 2-4 nm.

In an embodiment of the present invention, the orthosilicate is selected from tetraethyl orthosilicate or tetramethyl orthosilicate alone or in combination thereof.

In an embodiment, the reducing agent may be at least one selected from the group comprising: ammonia solution (30%), sodium hydroxide, and dodecylamine.

In an embodiment, the surfactant is selected from Cetyltrimethylammonium bromide, and Dodecylamine and Pluronic 123 (Poly(ethylene glycol)-block-poly (propylene glycol)-block-poly(ethylene glycol)).

In an embodiment, the reactor is made of Teflon or similar materials which are hydrophobic in nature.

In a particular embodiment, the reactor as disclosed in the present invention is tubular reactor made up of Teflon.

In a particular embodiment of the present invention, the density of the reaction mixture is less than that of the particles formed, with the hydrophobicity of the walls of the reactor maintained, the particles do not attach themselves to the wall and therefore clogging is avoided.

In a further embodiment of the present invention, the process has very low residence time (against prior arts which take even days) and unreacted material is recycled, resulting in zero discharge of the process. Yield is around 30-70%/cycle and remaining 70-30% is recycled.

### EXAMPLES

Following examples are given by way of illustration and therefore should not be construed to limit the scope of the invention.

### Example 1: Comparative Example: Batch Synthesis of Mesoporous Silica

CTAB (0.003-0.08M) and sodium hydroxide solution (0.0005-0.03M) were dissolved in methanol/water (50/50 v/v) solution. Trimethylbenzene (0.001-0.06M) was added to the solution with vigorous stirring followed by addition of TEOS (0.01-0.4 M) instantly. The reaction mixture was kept at temperature 55° C. for 7 hours under magnetic stirring. A white powder was collected by centrifugation, washed with methanol (three times). The final porous silica particles were obtained by calcining the solid at 550° C. for 6 hours. Particle size in the range of 400-600 nm was obtained having surface area and pore size of 1028 m²/gm and 2.4 nm, respectively.

### Example 2: Comparative Example: Semi-Batch Synthesis

The reaction was carried out in semi batch mode by keeping all the reaction parameters same as provided in Example 1 while only silica precursor (TEOS) added in the reactor in dropwise manner using a syringe pump over a period of 3 hours. The reaction was allowed to complete for subsequent 4 hours. Monodisperse particles with average diameter of 1.1 micron were formed, having surface area and pore size of 950 m²/gm and 2.12 nm respectively. With this semi batch process, we have achieved the particle size more than 1 micron by ensuring slower nucleation rate by controlled addition of TEOS.

### Example 3: Comparative Example: Semi-Batch Synthesis

The reaction was carried out in semi batch mode by keeping all the reaction parameters same as provided in Example 2 except that dodecyl amine was used as base instead of sodium hydroxide. Monodisperse particle was observed with average particle size of 210 nm.

### Example 4: Continuous Flow Synthesis of Mesoporous Silica Particles

An experimental set-up comprising of a tubular reactor made up of Teflon ⅛″ OD. tube in coiled form immersed in a constant temperature bath. A micromixer [Amar 3, 0.3 ml volume] was used for mixing of reactants at the inlet and reaction took place along the reactor length. Feed comprised of two separate stock solutions (i.e., a mixture of CTAB 0.008-0.1 M, water 5-46 M, NaOH 0.0005-0.03M and Methanol) and a mixture of TEOS 0.01-0.4 M and, TMB 0.001-0.06 M and methanol) pumped using two independent syringe pumps to facilitate the reaction at 55° C. with a residence time of 20 minutes. Resulting particles were polydispersed, hollow and broken. After 2 hours of continuous run, reactor got clogged. The average particle size was 900 (±60) nm with surface area and pore size of 922 m²/gm and 3.14 nm, respectively.

### Example 5: Teflon ⅛″ coiled reactor: two phase flow

In order to avoid clogging, air was introduced as a different phase to create recirculation and improve the mixing in the tube. Air flow rate kept as 30% of total flow rate. Rest all parameters were retained as in Example 4. Significant deposition was observed as the overall velocity was insufficient to push the particles out. Resulting particles were hollow, broken and ruptured.

### Example 6: Teflon ⅛″ coiled reactor: two phase flow

All the parameters remained same as in Example 5 except, air flow rate was kept as 50% of total flow rate. The resulting particles were rigid nanoparticles with size 200 nm along with some hollow and broken particles.

### Example 7: Teflon ⅛″ Coiled Reactor

Similar procedure as mentioned in example 4 was followed in this experiment except that out of the total amount of methanol, 25% methanol was taken in organic phase and remaining 75% kept in aqueous phase. The reaction carried out at 55° C. for 20 minutes residence time. Resulting particles were rigid of size in the range of 200 to 500 nm with no clogging for at least 2 hours.

### Example 8

While retaining the conditions in Example 7, except that out of total amount of methanol, 10% methanol was taken in organic phase and remaining 90% kept in aqueous phase, particles with relatively narrow particle size distribution. The surface area was greater than 1000 m²/gm and pore size was 3.2 nm. Conversion obtained from atomic absorption spectrometer was 70% and yield 32%. The reactor could be operated in clogging free manner up to 3 hours. Average size 495 nm (22% CV) and yield 35%.

### Example 9

Upon changing the base concentration to 0.06 M while keeping all other conditions same as in Example 8. Slight increase in particle size was observed thereafter. Average particle size is to be 590 nm (CV 16%) with surface area 667 m₂/gm and pore diameter 2.79 nm and around 50% yield.

### Example 10: Continuous Flow Synthesis Using CSTR in Series

Upon carrying out the experiment in Example 9 using four CSTRs connected in series having a total volume of 180 ml and for a total residence time 60 minutes, most of particles were deposited on wall and only supernatant was carried forward in subsequent CSTRs. This resulted in a bimodal particle size distribution having surface area 922 m²/gm and pore diameter of 2.78 nm.

### Example 11: PFR Followed by CSTR Teflon ⅛″

Experiment in Example 10 was repeated with a Teflon ⅛″ OD tubing as flow reactor followed by four CSTR in series, which resulted in particles having size from 700 nm to 1000 nm.

### Example 12: Tubular Reactor ⅛″ PTFE Tubing

Upon performing an experiment with the same conditions as in Example 9, while using a highly hydrophobic and extremely smooth inner surface PTEF tube as a reactor, average particle size obtained to be 520 nm (16% CV) with surface area of 771 m²/gm and pore diameter 2.78 nm without any clogging for several hours.

### Example 13: Effect of Residence Time

Upon repeating the conditions of Example 12, the yield was seen to increase 55% by increasing the residence time to 30 mins with no changes in particle size.

### Example 14: Large Scale Synthesis of Mesoporous Silica

Upon repeating the experiments with the conditions in Example 12, using a ¼″ (4.75 mm ID) PTEF tubing and with residence time of 20 minutes, the average particle size obtained was 780 nm (20% CV) with 51% yield. Continuous running of the reactor for 4 hours was possible without any clogging.

### Example 15

Upon repeating the experiments as in Example 14 except that instead of sodium hydroxide, an ammonia solution (30%, 0.1-0.7 M) is used as base at 45° C., the particle size 508 nm (CV 18%) was observed at 70% yield.

### Advantages of the Invention

The composition of the solution is selected such that it does not allow the suspension to stick to the wall of the reactor and thus can be run continuously for several hours to produce large quantities of tunable monodisperse mesoporous Silica particles with narrow particle size distribution, high surface area and uniform pore size.
A reliable and reproducible continuous flow synthesis protocol for mesoporous silica particles using sol gel method (stober process) and Scale-up through continuous process (20 gm/hr to 1000 gm/day) without clogging.
This process gives controllable particle size in the range of 400-1500 nm and size can be tuned by changing process parameters.
Reaction time dramatically decreased from several days to just few minutes.
The process has very low residence time (against prior arts which take even days) and unreacted material is recycled, resulting in zero discharge of the process. Yield is around 70%/cycle and remaining 30% is recycled.

1-10. (canceled)

11. A continuous process for synthesizing mesoporous silica particles, the continuous process comprising:
(a) preparing a first reaction mixture and a second reaction mixture at an inlet of a reactor, the first reaction mixture comprising a surfactant, a reducing agent, water, and methanol, the second reaction mixture comprising an orthosilicate, 1,2,4-trimethylbenzene (TMB), and methanol;
(b) passing and mixing the first reaction mixture and the second reaction mixture inside the reactor for a residence time from 10 minutes to 30 minutes at a temperature from 20° C. to 75° C.; and
(c) continuously running (b) for a time period of 2 hours to 4 hours to obtain the mesoporous silica particles;
wherein a contact angle between a surface of the reactor and the reaction mixtures inside the reactor during (b) and (c) is from 30° to 170°.

12. The continuous process of claim 11, wherein the mesoporous silica particles obtained in (c) are polydispersed, hollow, and broken with a surface area from 700 m²/g to 1300 m²/g and a pore size from 2 nm to 4 nm.

13. The continuous process of claim 11, wherein a ratio of orthosilicate: surfactant: reducing agent: TMB is from 1:1.5:10:1.2 to 1:25:80:10.

14. The continuous process of claim 11, wherein the first reaction mixture and the second reaction mixture are prepared in (a) using a micromixer.

15. The continuous process of claim 11, wherein:
the orthosilicate is tetraethyl orthosilicate or tetramethyl orthosilicate; and
the reducing agent is selected from ammonia solution, sodium hydroxide, dodecylamine, or combinations thereof.

16. The continuous process of claim 11, wherein the surfactant is selected from cetyltrimethylammonium bromide, poly(ethyleneglycol)-block-poly(propylene glycol)-block-poly(ethylene glycol)), or dodecylamine.

17. The continuous process of claim 11, wherein the reactor is a tubular reactor made of a hydrophobic material, particularly the reactor is Polytetrafluoroethylene (PTFE) tubular reactor.

18. The continuous process of claim 11, wherein the reactor is a polytetrafluoroethylene tubular reactor.

19. The continuous process of claim 11, wherein the continuous process is recyclable and results in zero discharge of unreacted material.

20. The continuous process of claim 11, wherein a yield of the mesoporous silica particles is from 30% to 70% per cycle.

21. The continuous process of claim 11, wherein the mesoporous silica particles comprise monodispersed mesoporous silica particles having a particle size from 400 nm to 1.5 μm; a surface area from 700 m²/g to 1300 m²/g; and a pore size from 2 nm to 4 nm.
